(19) United States
(12) Patent Application Publication
(10) Pub. No.: US 2015/0178610 A1
(43) Pub. Date: Jun. 25, 2015

(54) TEST SENSOR WITH CODE INFORMATION AND MANUFACTURING METHOD THEREOF

(71) Applicant: Hangzhou Sejoy Electronics & Instruments Co., Ltd, Hangzhou (CN)

(72) Inventors: Dongzheng HAN, Hangzhou (CN); Yunhua REN, Hangzhou (CN); Jungang CHEN, Hangzhou (CN); Yan LIAO, Hangzhou (CN); Jianhua WU, Hangzhou (CN)

(73) Assignee: Hangzhou Sejoy Electronics & Instruments Co., Ltd, Hangzhou (CN)

(21) Appl. No.: 14/259,510

(22) Filed: Apr. 23, 2014

(30) Foreign Application Priority Data
Dec. 20, 2013 (CN) 201310712806.9

(51) Int. Cl. G06K 19/067

(52) U.S. Cl. CPC G06K 19/067

(57) ABSTRACT

The present invention provides a test sensor with code information and a manufacturing method thereof. The manufacturing method of the test sensor with code information includes the following steps of: determining a corresponding relationship between code information of a test sensor and resistance or capacitance of an SMD resistor or SMD capacitor; and disposing the SMD resistor or SMD capacitor with a corresponding resistance or capacitance on a middle carrying plate or a base plate. The manufacturing method provided by the invention can solidify the code information into the test sensor by only two steps, and the manufacturing process is very simple. The production costs can be reduced greatly due to the SMD resistor or SMD capacitor. Further, this manufacturing method has extremely low requirements on manufacturing environment so that large-scale production can be achieved.

### CROSS-REFERENCE TO RELATED APPLICATIONS

This Non-provisional application claims priority under 35 U.S.C. §119(a) on Patent Application No(s). 201310712806.9 filed in Republic of China on Dec. 20, 2013, the entire contents of which are hereby incorporated by reference.

### BACKGROUND OF THE INVENTION

1. Field of the Invention

The present invention relates to a variety of medical test sensors and manufacturing processes thereof and, more particularly, to a test sensor with code information and a manufacturing method thereof.

2. Description of the Related Art

Test sensors are required in most medical detecting instruments. The production of the test sensors is easily affected by manufacturing environment (temperature, humidity, etc.), so different batches of test sensors have differences in characteristics and thus results detected by a detecting instrument using the different batches of test sensors have deviations. To reduce the error of detecting results, each batch of test sensors will have a corresponding piece of code information when they are delivered from a factory. By reading the code information, the detecting instrument calibrates its internal measuring program to eliminate deviations to obtain a precise detecting result.

Take glucometers for example. At present, glucometers in the market utilize two kinds of code identification methods.

1. Manual Code Adjustment by Users

Each bottle of the test sensors is labeled with code information when it is delivered from the factory. A user can manually adjust the code of the glucometer in accordance with the code information labeled on the test sensor bottle. However, the manual code adjustment is relatively complicated in operation, and the user is easily to adjust the code mistakenly. In particular, the glucometers are mostly used by old people. Thus, the error probability is high, and it is more likely to obtain incorrect detecting results.

2. Identification Via a Code Chip

Each bottle of the test sensors is additionally provided with a code chip when it is delivered from the factory, and the code information is stored in the code chip. During the detection, the code chip is inserted into the glucometer at first, and then the glucometer reads the code information from the code chip to achieve calibration. Subsequently, the user inserts in the test sensor for detection. The code chip identification method avoids human errors resulted from the manual code adjustment. However, since the chip and the glucometer are packaged separately, it is likely to have errors and transposition accidents during the packaging, thereby causing the detecting results incorrect. Furthermore, as the chip is relatively small and easily lost, once the chip is lost, the user is unable to perform detection via the test sensors; moreover, the whole bottle of test sensors will be wasted.

In view of the above problems, there have been three novel manufacturing processes of the test sensors at present, whereby the manufactured test sensors have code information themselves.

The first manufacturing process is printing resistors on surfaces of the test sensors. By printing the resistors different in length and width, the resistors have different resistances. The resistors with different resistances correspond to different code information. However, this manufacturing process of the test sensors is complicated and has extremely strict requirements on the manufacturing environment (temperature, humidity, etc.), and production costs are considerably high. Furthermore, as the resistors are disposed on base plates of the test sensors by printing, it is difficult to precisely control the resistances of the resistors, and the industrial yield is quite low. Therefore, this manufacturing process can only be applicable to small-scale production rather than industrial production.

The second manufacturing process is adding electrode assemblies to the test sensors to represent the code information. By etching on the added electrode assemblies to make the electrodes connected or cut off, the electrode assemblies are binary coded. Alternatively, the binary coding can also be performed by punching through holes or blind holes or by disposing saw teeth in different states on the electrodes. However, the procedure of this manufacturing process is complicated, and the production costs are too high. Furthermore, the number of the pieces of the code information, which the test sensors made by this manufacturing process can represent, is no more than two to the power of the number of the coded electrodes. In other words, the test sensors made by the second manufacturing process can only represent few pieces of code information, and the manufacturing process is not applicable to large-scale production.

The third manufacturing process improves a code identification method. The code information is printed on blood glucose test sensors in a form of bar code, and then the code is combined with a transducer. There are four conductive carbon layers built-in the transducer, three of which are connected to three resistors in series, respectively, and are cut off by laser beams, respectively, thus to generate eight groups of identification codes. Similar to the second process, the production costs of this process are high due to the additional transducer. Furthermore, the number of the pieces of the code information, which the test sensors made by this manufacturing process can represent, is no more than two to the power of the number of the resistors. The manufacturing process is not applicable to industrialization and large-scale production.

### BRIEF SUMMARY OF THE INVENTION

To reduce production costs, the present invention provides a test sensor with code information and a manufacturing method thereof.

To achieve the above objective, the present invention provides a manufacturing method of a test sensor with code information, including the following steps of: determining a corresponding relationship between code information of a test sensor and resistance or capacitance of a surface mounted device (SMD) resistor or SMD capacitor; and disposing the SMD resistor or SMD capacitor with a corresponding resistance or capacitance on a middle carrying plate or a base plate.

In one embodiment of the invention, after determining the corresponding relationship between the code information of the test sensor and the resistance or capacitance of the SMD resistor or SMD capacitor, the manufacturing method may further include the following step of: performing a characteristic test to the test sensor to obtain a test result and determining a corresponding resistance or capacitance according to the test result.

In one embodiment of the invention, the SMD resistor or SMD capacitor corresponding to the code information of the test sensor may be disposed on the middle carrying plate or base plate by bonding, hot melting, or welding.

In one embodiment of the invention, the base plate may be a test sensor substrate.

In one embodiment of the invention, the middle carrying plate may be a flexible printed circuit board, and the SMD resistor or SMD capacitor corresponding to the code information of the test sensor may be disposed on the flexible printed circuit board by a surface mount technology.

In one embodiment of the invention, the manufacturing method may further include the following step of: integrating the flexible printed circuit board with the base plate.

In one embodiment of the invention, after disposing the SMD resistor or SMD capacitor with the corresponding resistance or capacitance on the middle carrying plate or base plate, the manufacturing method may further include the following step of: reading the resistance or capacitance of the SMD resistor or SMD capacitor to obtain the corresponding code information.

To achieve another objective, the invention further provides a test sensor with code information, including a middle carrying plate or a base plate and an SMD resistor or SMD capacitor with a resistance or capacitance corresponding to code information. The SMD resistor or SMD capacitor is disposed on the middle carrying plate or base plate.

In one embodiment of the invention, the SMD resistor or SMD capacitor may be disposed on the middle carrying plate or base plate by bonding, hot melting, or welding.

In one embodiment of the invention, the middle carrying plate may be a flexible printed circuit board, and the SMD resistor or SMD capacitor may be disposed on the flexible printed circuit board by a surface mount technology.

In conclusion, according to the manufacturing method of the test sensor provided by the present invention, code information can be solidified into the test sensor by very few steps, and the manufacturing process is very simple. The advantage of utilizing the SMD resistor or SMD capacitor rather than other types of electronic elements is that those components are standard components in electronics industry and they are accurate and could be easily processed by surface mounting technology (SMT), thereby reducing the costs significantly. Moreover, this manufacturing method has extremely low requirements on manufacturing environment so that large-scale production can be achieved. The manufacturing method in the invention establishes the corresponding relationship between the resistance or capacitance and the code information. The corresponding relationship may have plenty of choices depending on different kinds of algorithms, and each algorithm can provide dozens or even hundreds of pieces of code information, so that the defect that only few or just over ten pieces of code information can be provided in the prior art is overcome.

The test sensor provided by the present invention has the solidified code information, so that the problem that errors are likely to be resulted from manual code adjustment or from using a code chip in the prior art is overcome. With the application of the SMD resistor or SMD capacitor, the test sensor is simple in structure and convenient to manufacture.

In addition, according to one embodiment of the invention, the test sensor may use the flexible printed circuit board as the middle carrying plate, and the SMD resistor or SMD capacitor is disposed on the flexible printed circuit board by the surface mount technology (SMT). This manufacturing process is much simpler and standard in electronics industry, greatly reducing the production costs and facilitating the large-scale production.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a manufacture method of a test sensor with code information according to the first embodiment of the present invention;

FIG. 2 is a schematic diagram showing a manufacture method of a test sensor with code information according to the second embodiment of the invention;

FIG. 3 is a schematic diagram showing the test sensor manufactured by the method according to the second embodiment of the invention; and

FIG. 4 is an exploded view of FIG. 3.

### DETAILED DESCRIPTION OF THE INVENTION

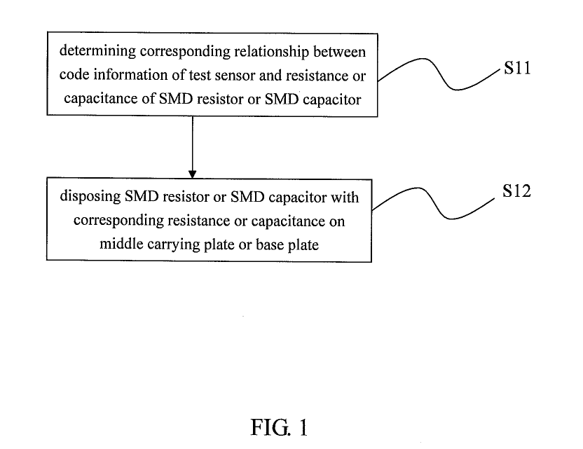

FIG. 1 is a schematic diagram showing a manufacture method of a test sensor with code information according to the first embodiment of the present invention. As shown in FIG. 1, the manufacturing method in the embodiment includes step S11 and step S12.

In step S11, a corresponding relationship between code information of a test sensor and resistance or capacitance of a surface mounted device (SMD) resistor or SMD capacitor is determined. How to establish a one-to-one corresponding relationship between the resistance or capacitance and the code information will be described in details as below by an example. However, this is not limited in the present invention. In other embodiments, the establishment of the corresponding relationship may be realized by different algorithms.

In the art, one presentation way of code information is a linear equation Y=aX+b. Each specific piece of code information corresponds to a specific straight line. Straight lines corresponding to different code information are not overlapped with each other. That is, the straight lines have different values of the slope a or intercept b, or both the values of the slop a and intercept b of the straight lines are different. The values of a and b are determined by the material of the test sensor, chemical characteristics, manufacturing environment and other factors.

Resistance R₁ or capacitance F₁ is set as an initial value, ΔR or ΔF (not zero) is regarded as one step value or increment value, and n resistance values or capacitance values are stored, so that a corresponding relationship table is established. For example, in the corresponding relationship table of the resistance, the initial resistance value is 10KΩ, each 1 KΩ is regarded as the step value, and 60 resistance values are stored in total.

When the code information of the first batch of test sensors is detected to be Y=a₁X+b₁, the code information is made to correspond to R₁ or F₁. When the code information of the second batch of test sensors is detected to be Y=a₂X+b₂, a₂ and a₁ and b₂ and b₁ are compared with each other, respectively. If the case a₂≠a₁ or b₂≠b₁ occurs, the second batch of test sensors are made to correspond to R₂ (resistance value thereof equals R1+ΔR) or F₂ (capacitance value thereof equals F₁+ΔF). If the case a₂=a₁ and b₂=b₁ occurs, it is proved that the second batch of test sensors are actually the same as the first batch of test sensors, so that the second batch of test sensors are made to correspond to R₁ or F₁. In such a way, n batches of the test sensors can correspond to the stored n resistance values or capacitance values, and the whole corresponding relationship table can be established.

In step S12, the SMD resistor or SMD capacitor with a corresponding resistance or capacitance is disposed on a middle carrying plate or a base plate. As the resistances or capacitances are in one-to-one corresponding relationship to the code information, the test sensor with a specific SMD resistance or capacitance has the unique corresponding code information.

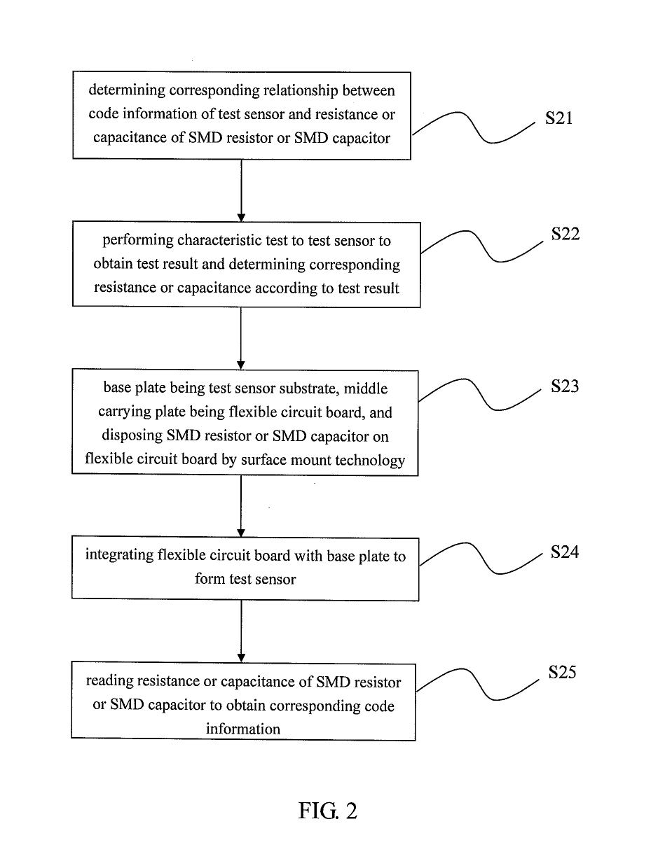

FIG. 2 is a schematic diagram showing a manufacture method of a test sensor with code information according to the second embodiment of the invention. As shown in FIG. 2, the manufacturing method in the embodiment includes step S21 to step S25.

In step S21, a corresponding relationship between code information of a test sensor and resistance or capacitance of an SMD resistor or SMD capacitor is determined. In this embodiment, after step S21, the manufacturing method of the test sensor further includes the following step S22: performing a characteristic test to the test sensor to obtain a test result and determining a corresponding resistance or capacitance according to the test result. In this embodiment, during the manufacture of the test sensor (for example, a blood glucose test sensor), it is required to detect the inherent characteristics of the test sensor at first. The characteristics of the test sensor itself correspond to the unique code information. Thus, the resistance or capacitance of the SMD resistor or SMD capacitor, which should be disposed on the test sensor, may be determined. However, the invention is not limited thereto. In other embodiments, the manufacturing method of the test sensor may not include step S22. Since manufacturing materials and environment of some kinds of test sensors are specific, the code information can be determined only depending on the manufacturing materials of the test sensors, without detecting the characteristics of the test sensors, and the corresponding resistance or capacitance can be determined accordingly.

In the embodiment, the manufactured test sensor has both a middle carrying plate and a base plate. The manufacturing method further includes step S23. The base plate is a test sensor substrate, the middle carrying plate is a flexible printed circuit board, and the SMD resistor or SMD capacitor is disposed on the flexible printed circuit board by a surface mount technology. Using a flexible printed circuit board as the middle carrying plate enables the whole test sensor to be film-shaped, which is convenient for cutting and manufacturing and also easy to fix the middle carrying plate and the base plate. The manufactured test sensor has both the middle carrying plate and the base plate, so that the manufacturing process is simpler. As the peak reflow temperature of the surface mount technology is relatively high, the SMD resistor or SMD capacitor is disposed on the middle carrying plate at first. After reflow soldering, the cooled middle carrying plate is bonded onto the base plate to maintain the activity of biochemical enzymes on the base plate. Meanwhile, it is convenient to reserve a cavity for forming a loading slot.

However, the invention is not limited thereto. In other embodiments, the SMD resistor or SMD capacitor may be disposed on the middle carrying plate or the base plate by bonding, hot melting, or welding.

In the embodiment, the manufacturing method of the test sensor further includes step S24: integrating the flexible printed circuit board and the base plate to form the test sensor. In the embodiment, the flexible printed circuit board and the base plate can be integrated by means of bonding. However, the invention is not limited thereto. In other embodiments, step S24 may be omitted when the test sensor has only one of the base plate and the middle carrying plate.

In the embodiment, after step S24, the manufacturing method of the test sensor further includes step S25: reading the resistance or capacitance of the SMD resistor or SMD capacitor to obtain the corresponding code information. Specifically, the test sensor with the code information is inserted into a detector, and then the detector is started to automatically detect the SMD resistor or SMD capacitor thus to obtain the corresponding resistance or capacitance. A corresponding relationship table of the resistances or capacitances and code information has already been solidified in a program of the detector. The detector accesses the corresponding relationship table to obtain the corresponding code information.

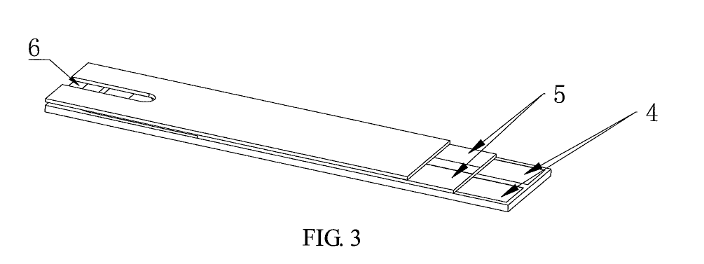

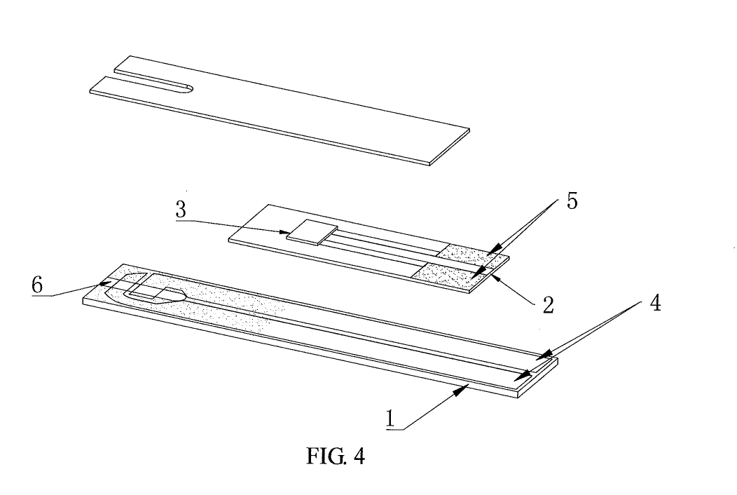

FIG. 3 is a schematic diagram showing the test sensor manufactured by the method according to the second embodiment of the invention. FIG. 4 is an exploded view of FIG. 3. Please refer to FIG. 3 and FIG. 4 together.

In the embodiment, the test sensor includes a cover plate, a base plate 1, a middle carrying plate 2, and an SMD resistor or SMD capacitor 3. In the embodiment, the base plate 1 is a test sensor substrate and has corresponding biochemical enzymes according to different purposes of the test sensor. The middle carrying plate 2 is a flexible printed circuit board. The SMD resistor or SMD capacitor 3 with the resistance or capacitance corresponding to the code information is disposed on the flexible printed circuit board by the surface mount technology. The flexible printed circuit board 2 and the base plate 1 are integrated to form the test sensor.

However, the invention is not limited thereto. In other embodiments, the middle carrying plate 2 may be other industrial circuit boards. The position of the SMD resistor or SMD capacitor 3 is also not limited in the present invention. In other embodiments, the test sensor may only include the base plate 1 rather than the middle carrying plate 2, and the SMD resistor or SMD capacitor 3 may be directly disposed on the base plate 1. In another embodiment, the test sensor may only include the middle carrying plate 2 rather than the base plate 1, and the SMD resistor or SMD capacitor 3 may be directly disposed on the middle carrying plate 2. At that time, the middle carrying plate 2 is regarded as the substrate of the whole test sensor. The method of disposing the SMD resistor or SMD capacitor 3 is also not limited in the invention. In other embodiments, the SMD resistor or SMD capacitor 3 may be disposed on the middle carrying plate 2 or the base plate 1 by bonding, hot melting, or welding.

In the embodiment, the test sensor further includes two working electrodes 4, two startup electrodes 5, and a loading slot 6. The working electrodes 4 are used for detecting a sample. The startup electrodes 5 are used for starting the detector. The substance to be detected (for example, blood) is dripped into the loading slot 6. However, the invention is not limited thereto. In other embodiments, the test sensor may have a single electrode only, and the startup electrodes 5 and the working electrodes 4 may be integrated into one electrode.

In the embodiment, the two working electrodes 4 are disposed on the base plate 1, the two startup electrodes 5 are disposed on the middle carrying plate 2, and the SMD resistor or SMD capacitor 3 is electrically connected with the two startup electrodes 5. In the embodiment, the SMD resistor or SMD capacitor 3 is electrically connected with the two startup electrodes 5 via metal. However, the invention is not limited thereto. In other embodiments, the SMD resistor or SMD capacitor 3 may be adjacent to the two startup electrodes 5 and be directly welded between the two startup electrodes 5 to realize the electrical connection.

The test sensor provided by the present invention may be a blood glucose test sensor, a hemoglobin test sensor, a glycosylated hemoglobin test sensor, a progesterone test sensor, a blood fat test sensor, and so on. Various kinds of chemical test sensors and other biochemical test sensors requiring code information shall fall into the scope of the test sensors provided by the invention.

How to perform detection by the test sensor according to the embodiment of the invention will be described in details as below.

A test sensor slot of the detector is provided therein with two working electrode spring leaves and two startup electrode spring leaves, which correspond to the working electrodes 4 and the startup electrodes 5 of the test sensor and can be electrically contacted with the working electrodes 4 and the startup electrodes 5, respectively. The test sensor of the invention is inserted into the detector (for example, a glucometer) at first. Then, the startup electrode spring leaves and the startup electrodes 5 of the detector are conducted, so that the detector is started. As the SMD resistor or SMD capacitor 3 is electrically connected with the startup electrodes 5, the detector can automatically detect the resistance or capacitance of the SMD resistor or SMD capacitor 3 to obtain the corresponding resistance value or capacitance value.

A program is stored in the detector. The corresponding relationship between the resistance or capacitance and the code information is recorded in the program. The corresponding code information can be found from the corresponding relationship through the detected resistance or capacitance. In specific applications, the detector may be stored with a corresponding relationship table of resistances/capacitances and codes. Subsequently, the detector performs measurement via the working electrodes 4 and calculates and calibrates the final detecting result (for example, concentration of the blood glucose) according to the code information read in advance.

In conclusion, according to the manufacturing method of the test sensor provided by the present invention, code information can be solidified into the test sensor by very few steps, and the manufacturing process is very simple. The advantage of utilizing the SMD resistor or SMD capacitor rather than other types of electronic elements is that those components are standard components in electronics industry and they are accurate and could be easily processed by surface mounting technology (SMT), thereby reducing the costs significantly. Moreover, this manufacturing method has extremely low requirements on manufacturing environment so that large-scale production can be achieved. The manufacturing method in the invention establishes the corresponding relationship between the resistance or capacitance and the code information. The corresponding relationship may have plenty of choices depending on different kinds of algorithms, and each algorithm can provide dozens or even hundreds of pieces of code information, so that the defect that only few or just over ten pieces of code information can be provided in the prior art is overcome.

The test sensor provided by the present invention has the solidified code information, so that the problem that errors are likely to be resulted from manual code adjustment or from using a code chip in the prior art is overcome. With the application of the SMD resistor or SMD capacitor, the test sensor is simple in structure and convenient to manufacture.

In addition, according to one embodiment of the invention, the test sensor may use the flexible printed circuit board as the middle carrying plate, and the SMD resistor or SMD capacitor is disposed on the flexible printed circuit board by the surface mount technology. This manufacturing process is much simpler and standard in electronics industry, greatly reducing the production costs and facilitating the large-scale production.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A manufacturing method of a test sensor with code information, comprising the following steps of:
determining a corresponding relationship between code information of a test sensor and resistance or capacitance of an SMD resistor or SMD capacitor; and
disposing the SMD resistor or SMD capacitor with a corresponding resistance or capacitance on a middle carrying plate or a base plate.

2. The manufacturing method of a test sensor with code information according to claim 1, wherein after determining the corresponding relationship between the code information of the test sensor and the resistance or capacitance of the SMD resistor or SMD capacitor, the manufacturing method further comprises the following step of: performing a characteristic test to the test sensor to obtain a test result and determining a corresponding resistance or capacitance according to the test result.

3. The manufacturing method of a test sensor with code information according to claim 1, wherein the SMD resistor or SMD capacitor corresponding to the code information of the test sensor is disposed on the middle carrying plate or base plate by bonding, hot melting, or welding.

4. The manufacturing method of a test sensor with code information according to claim 1, wherein the base plate is a test sensor substrate.

5. The manufacturing method of a test sensor with code information according to claim 4, wherein the middle carrying plate is a flexible printed circuit board, and the SMD resistor or SMD capacitor corresponding to the code information of the test sensor is disposed on the flexible printed circuit board by a surface mount technology.

6. The manufacturing method of a test sensor with code information according to claim 5, further comprising the following step of: integrating the flexible printed circuit board with the base plate.

7. The manufacturing method of a test sensor with code information according to claim 1, wherein after disposing the SMD resistor or SMD capacitor with the corresponding resistance or capacitance on the middle carrying plate or base plate, the manufacturing method further comprises the following step of: reading the resistance or capacitance of the SMD resistor or SMD capacitor to obtain the corresponding code information.

8. A test sensor with code information manufactured by the method according to claim 1, comprising:
a middle carrying plate or a base plate; and
an SMD resistor or SMD capacitor with a resistance or capacitance corresponding to code information, disposed on the middle carrying plate or base plate.

9. The test sensor with code information according to claim 8, wherein the SMD resistor or SMD capacitor is disposed on the middle carrying plate or base plate by bonding, hot melting, or welding.

10. The test sensor with code information according to claim 8, wherein the middle carrying plate is a flexible printed circuit board, and the SMD resistor or SMD capacitor is disposed on the flexible printed circuit board by a surface mount technology.
